(19) United States
(12) Patent Application Publication
(10) Pub. No.: US 2009/0210252 A1
(43) Pub. Date: Aug. 20, 2009

(54) METHOD AND APPARATUS FOR REAL TIME ANALYSIS OF MEDICAL ORDERS

(76) Inventor: Marc Silver, Longport, NJ (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/261,466

(22) Filed: Oct. 30, 2008

Related U.S. Application Data
(60) Provisional application No. 61/030,077, filed on Feb. 20, 2008.

(51) Int. Cl. G06Q 50/00

(52) U.S. Cl. 705/3

(57) ABSTRACT

A customized, automated tracking system (CATS) and method is disclosed that provides an interface between medical records relating to medication records and clinical laboratory result records. As new records are created or updated, the record is input into a central repository where medication records and laboratory records for a patient/resident are stored. When new medication orders are placed, the central data repository is queried and comparative analysis is performed. Clinical results are compared to the patient's/resident's diagnosis and prescribed medications to determine the appropriateness of the course of treatment. If an order is inappropriate for a given diagnosis, or if the medication ordered is contra-indicated, the central data repository notifies at least one of the primary physician, filling pharmacy or the patient. Historical data is received and archived for later analysis. The data for many patients may be organized and analyzed based on a common characteristic of the medical records.

This application claims the benefit of U.S. Provisional Patent Application 61/030,077 filed on Feb. 20, 2008 which is incorporated by reference as if fully set forth.

### FIELD OF INVENTION

This invention relates to the field of healthcare. More particularly, the invention relates to analysis of healthcare orders at the time they are placed.

### BACKGROUND

Healthcare providers are relied upon for many of our healthcare needs. When a patient/resident experiences a medical condition, a healthcare provider will examine the patient/resident and make a medical determination based on the advanced training and knowledge of the healthcare provider. The healthcare provider then decides on an appropriate course of action to treat the medical condition. The patient's/resident's history of medication is an important factor in determining an appropriate course of treatment. The healthcare provider needs to know the patient's/resident's history of drug allergies before prescribing medications to ensure the patient/resident will not have an allergic reaction to the treatment. Additionally, some medications may react with other medications and produce undesirable side effects. If the healthcare provider knows the medications the patient/resident is currently taking, they can make an informed decision and avoid medications that may react to medications already being taken by the patient.

Other valuable information comes from clinical test results. Through testing of patient/resident samples, information regarding infections, blood clotting characteristics, nutritional information and indicators of disease can be identified and managed. For instance, once it is determined that a bacterial infection exists, the infection can be cultured and tested against current antibiotics to determine which antibiotics are most effective on the organism and to which antibiotics the organism is resistant.

With regard to blood thinning therapies, medications are given to certain patients at risk for clots that may travel through the blood stream and block vital arteries. Blood clotting times are closely monitored on patients undergoing blood thinning therapies and a historical record of blood tests are analyzed to maintain proper dosing. Similarly, treatments for anemia require close and ongoing monitoring of patients' hemoglobin levels to determine the appropriateness of the treatment and the patient's/resident's ongoing need for treatment. Anemia drugs are expensive and the proper dosing is crucial.

Traditionally a written entry is kept in the patient/resident chart logging the patient's/resident's current condition, such as blood pressure, body temperature, weight, height and other data as well as a history of past conditions and treatments including results from previous test results that were performed on the patient. These entries are relied on to provide the healthcare provider with a context in which to make future decisions. For example, the chart may include medications to which the patient/resident has an allergy, alerting the healthcare provider not to prescribe medications from that family of medications. A history of clinical results may indicate to a healthcare provider that a current course of treatment is not producing the desired effect. In such a case, the healthcare provider may decide to change the medication administered, or to adjust the dosage of the current medication.

The connections between medications and clinical laboratory results provide an important insight as to the patient's/resident's overall medical condition. Clinical results may indicate a particular organism causing infection is resistant to certain medications thereby making the administration of such medications inappropriate and creating an unnecessary expense. Laboratory results may also indicate that a current course of treatment is or is not resulting in a desired medical outcome. For example, a history of hemoglobin levels compared with a historical record of anemia medications by dosage may indicate the clinical outcome of a particular treatment. A complete history also allows for the healthcare provider to identify potential drug interactions or counter-indications based on a particular patient's/resident's situation. The healthcare provider must keep a complete chart on the patient/resident and continually review the chart along with currently available treatment options to treat each medical condition.

Traditionally, patient/resident charts are kept in paper files in the healthcare provider's office or healthcare facility where the patient/resident has been for treatment. However, a typical patient/resident may see more than one healthcare provider, such as a general practitioner (GP) for general medical issues, and specialists for other conditions such as cardiac treatments. Additionally, medical conditions may require a stay in a healthcare facility such as a hospital, rehabilitation center or nursing home where other healthcare providers care for the patient.

In each of these scenarios, the treating healthcare provider is not in the best position to render treatment without knowledge of all the patient's/resident's medical information, which may only be obtained from a complete picture of the patient's/resident's history. This is difficult when medical information is distributed across multiple locations under the control of various healthcare providers or healthcare facilities.

Standards to define electronic medical records (EMR) have been developed, such as HL7 and openEHR to facilitate sharing of medical information electronically. While these standards do allow transfer of medical information, the information is transferred as images of written pages that must be physically viewed, read and interpreted. This does not allow for an automated means of verifying or analyzing medical information and it cannot be done in real time, as the information must be received, processed and viewed by a healthcare provider to be usable.

It would be beneficial to have a healthcare information storage and analysis system that could automatically analyze medical information in real-time.

### SUMMARY

A customized, automated tracking system (CATS) and method is disclosed that provides an interface between medical information relating to medication orders and clinical laboratory results. As new orders are written or orders are updated, medical information is put into a central repository where medication information and clinical laboratory results for a patient/resident are stored. When new orders are placed, the central data repository is queried and comparative analysis is performed. Clinical results may be compared to the patient's/resident's diagnosis and prescribed medications to qualify the order based on the appropriateness of the course of treatment. If an order is inappropriate for a given diagnosis, or if the medication ordered is contra-indicated, the central data repository may notify at least one of the primary doctor, the filling pharmacy, a facility and/or the patient.

Historical medical information is received and archived for later analysis. A patient's/resident's stored history of both medications and dosages and related clinical results may be organized into a single report or graph to provide the individual's response to the current course of medication. Duplicate medications or unnecessary medication may be identified and stopped, thereby providing further cost saving benefits.

In addition to comparative analysis with regard to a single patient's/resident's medical history, analysis may also be done on a selected population. For instance, all patients in a particular healthcare facility may be considered. By analyzing healthcare information relating to a single facility it is possible a source of infection that is spreading in the facility and identify the sensitivities of the organism to ensure that the proper antibiotics are prescribed to make treatment appropriate both from a cost perspective and a clinical outcome perspective. Antibiotics may be assessed based on the sensitivity of an organism to the prescribed antibiotic. If based on the organism a more effective antibiotic is available, the healthcare provider may be notified by the system of a possible alternative treatment option.

The histories of patients being treated by a single healthcare provider may also be analyzed to audit or evaluate the treatment plans of that healthcare provider. If a particular treatment favored by the healthcare provider is resulting in unacceptable clinical outcomes, notification may occur in real-time by the system due to the system's analytical capabilities.

Healthcare information is imported in a format that allows the real-time automated analysis of the content of the information. The information does not need to be viewed by the healthcare provider to provide the benefits of the system. Additionally, entire populations within a region may be analyzed to provide healthcare administrators with cost effectiveness analysis and treatment appropriateness analysis for forming baselines for accepted treatments and reimbursements for third party reimbursement payers.

In one embodiment, when an order is being written, a healthcare provider may be presented with a series of pre-determined questions relating to the patient/resident or the treatment or test under consideration through a web browser interface. Through the responses to these questions, correlations between diagnoses, patients, test results, and medications may be made. For instance, a medication being considered may be inappropriate for a given diagnosis. The system would recognize this and indicate to the healthcare provider that the medication is not deemed appropriate for the diagnosis.

If a patient/resident is diagnosed with an infection, the strain of organism and its resistances may be compared to infections discovered in a facility where the patient/resident is being treated. Results from other patients may be compared to the patient's/resident's infection and trends such as epidemics or resistant strains of organism can be identified sooner and managed. Outbreaks of dangerous organisms such as Methicillin Resistant Staphylococcus Aureus (MRSA) may be identified early and steps may be taken to prevent the spread.

Through carefully crafted questions, clinical trends or ongoing treatments that may need altering are identified earlier than is possible with a manual review of a patients file. The healthcare provider's attention may be drawn to test results that are indicated by the responses to the questions that were outside the scope of the healthcare provider's original interest, thereby providing assistance in providing high quality care.

### BRIEF DESCRIPTION OF THE DRAWINGS

FIG. 1 shows an overview of a system for healthcare order analysis;

FIG. 2 is a block diagram showing a process of analysis for a healthcare order;

FIG. 3 shows an overview of a system for healthcare order entry and evaluation;

FIG. 4 shows a sample report of medication orders by physician;

FIG. 5 shows a sample report indicating missing or suggested clinical laboratory tests based on medications;

FIG. 6 shows a sample report indicating medications that are inappropriate for a given diagnosis;

FIG. 7 shows a graph of a patients clinical lab result and medication history;

FIG. 8 shows example graphs of a patient's/resident's clinical lab results compared associated with medication;

FIG. 9 shows an example graph of clinical lab results associated with patients treated by the same doctor;

FIG. 10 shows an example graph indicating clinical lab results within a healthcare facility;

FIG. 11 shows an example graph comparing clinical lab results across multiple healthcare facilities;

FIG. 12 is a example report of prescription costs by payer class;

FIG. 13 is a block diagram of a system of medication order entry and evaluation;

FIG. 14 is a block diagram illustrating the import of a healthcare order into a data repository;

FIG. 15 shows a method of evaluating a healthcare order; and

FIG. 16 is a block diagram of a system to communicate analysis of an order before the order is performed.

### DETAILED DESCRIPTION OF THE PREFERRED EMBODIMENTS

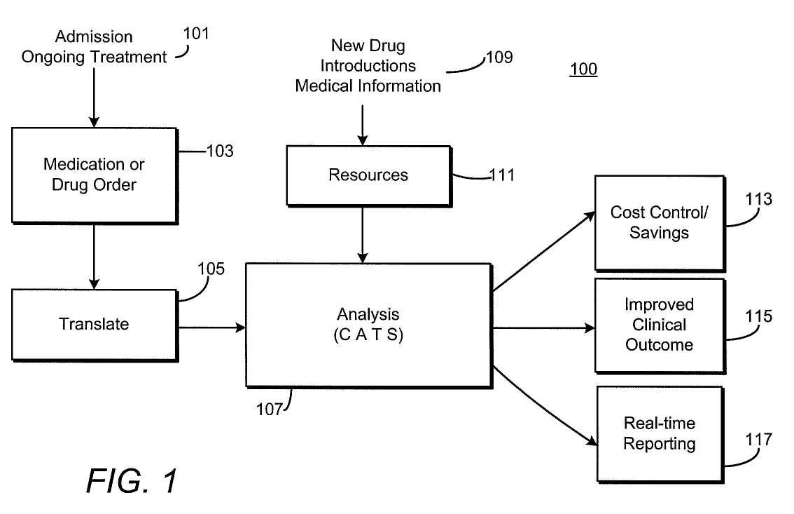

FIG. 1 is a block diagram showing an overview of a system 100 of entering and analyzing healthcare orders. A medication order 103 is generated when a patient/resident is being treated by a healthcare provider. Patient/resident treatment may be based on a new admission, or part of ongoing treatment between the patient/resident and the healthcare provider 101.

When it is determined that a new order 103 for a medication is indicated, the order 103 is written and/or entered into a computer system via a suitable interface. As part of the order entry, the order is translated 105 and the substantive aspects of the order are extracted and translated into a standardized or proprietary format for entry into system for analysis 107. Substantive information contained in the medication order 103 may include: date of the order, patient/resident name and demographic information patient/resident ID number, healthcare facility, drug name, dosage and form (eg. tablet, liquid, intravenous (IV)). After translation 105, the substantive information is stored in an analysis unit 107 which may be a database or the like. The operation of the analysis unit 107 will be described in greater detail below. In addition to the substantive information relating to placed orders 103, additional resources 111 may be stored within the analysis unit 107 to provide a complete medical picture relating to the placed order 103.

Typically, incoming orders will relate to a new order for a medication or drug or alternatively, an order for a clinical laboratory test. Resources 111 other than the substantive information derived from entered orders 103 provide additional input to the analysis system 107. With respect to medications, additional resources 111 such as side effects, clinical indications, dosages, and interactions may be included in the analysis unit 107 and made available for analysis of incoming orders 103. Other resources such as general medical information may be stored in the analysis unit 107. The medical information may come from healthcare professionals, such as physicians, dieticians or may include clinical information such as normal range levels for various clinical laboratory tests. When a new order 103 is placed, the substantive information relating to the order is stored in a database in the analysis unit 107. Analysis is performed based on the substantive information from the order to provide real-time feedback based on the available resources 111 also historical healthcare information stored in the database in the analysis unit 107. The medication order 103 is compared to clinical results and basic medical knowledge available to the analysis unit 107 and the appropriateness of the prescribed treatment is determined. Analysis results that indicate the ordered me 103 is not indicated based on the patient's/resident's medical history may be communicated back to the healthcare provider placing the order, or alternatively or in addition, the findings may be communicated to the party filling the order, such as a pharmacy.

In addition to the review and analysis of current orders, analysis 107 may be performed past healthcare information based on pre-selected criteria. For example, a doctor may be cross-referenced by patient/resident information stored in the analysis unit 107 and a compilation of results for patients being treated by the doctor may be viewed for analysis. Likewise, results relating to a population of patients being treated at a common healthcare facility, such as a nursing home, may be grouped together in an analysis of medical information for that population. Analysis may provide information relating to an infection that is present in a facility, or provide sensitivity information to a strain of bacteria that may be infecting a population under consideration. In this way, a healthcare provider attempting to treat a bacterial infection is informed to what antibiotics would be ineffective against the infection based on cultures and sensitivities of other patients in the facility.

Other information relating to a patient, such as a potentially harmful drug interactions may be identified because healthcare information from the patient's/resident's previous medication orders 103 has been stored in the analysis unit 107 and are available for analysis when a new order 103 is placed. Based on a patient's/resident's history, other considerations, such as poly-pharmacy indications relating to a particular diagnosis may be identified and brought to the attention of the healthcare provider. Poly-pharmacy refers to a case where multiple medications are being used to treat the same diagnosis. Alternative medications, such as newly introduced pharmaceuticals, generic equivalents, or less expensive forms of the medication may be suggested, alternatively, if poly-pharmacy is identified, duplicative medications may be identified so the healthcare provider may consider discontinuation of that treatment.

As a result of the analysis 107 performed on the order 103, benefits such as cost control 113, improved clinical outcomes 115 and real-time reporting 117 are realized. Cost control 113 is realized through the identification and correction of medication orders 103 that are either inappropriate for a given diagnosis, or are identified as unnecessary based on compiled historical data.

An improved clinical outcome 115 may be realized through analysis 107 of new medication orders 103. For example, if an improper dosage for a given patient/resident was ordered, the analysis unit 107 performs analysis based on the received order 103 and the stored medical information on the patient, combined with the other medical resources 111 described above. Should the analysis results indicate that the drug ordered is not correct or that the dosage is incorrect, corrective action may be taken to ensure that the patient/resident gets the most appropriate treatment. In this way, the patient's/resident's clinical outcome is improved 115. The patient's/resident's condition is treated sooner and time is not lost when the patient/resident takes an improper medication or dosage before the problem is identified and corrective action is taken.

Real-time reporting 117 is made possible through analysis 107 because all of the past and present medical information for the patient/resident are available to the analysis unit 107 at the time the order is entered or the request for information is made. When an inquiry is made, either through the entry of a new order 103 or through an ongoing treatment 101 request for information, information relating to the patient, including medications and clinical test results are available for compilation and display. In addition to the most current results, historical trends may be plotted based on past medical information. Over a time period, medication dosages and related clinical laboratory test results may be graphed and presented in reports 117. Currently placed orders 103 may be revised based on past results and future expectations. The reports 117 may be delivered electronically, such as on a computer display, or may be generated into a computer file that may be downloaded or e-mailed.

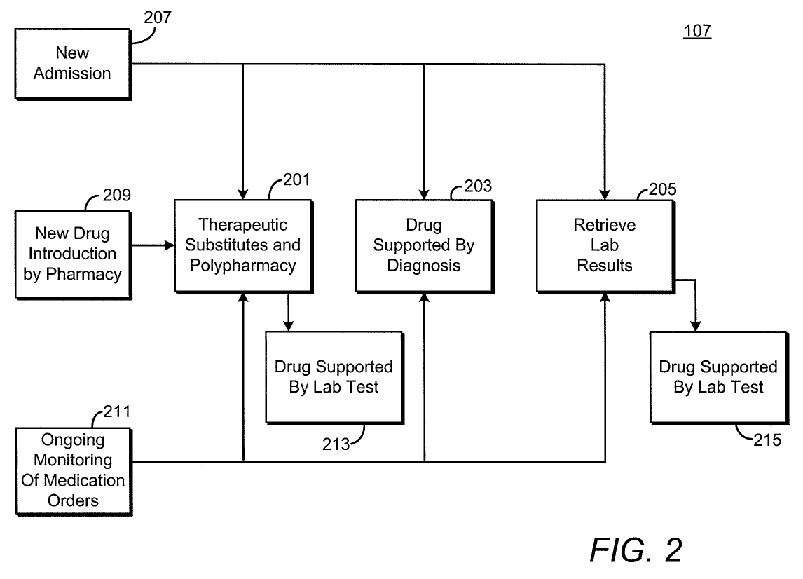

FIG. 2 is a block diagram showing an overview of the analysis process in the analysis unit 107 of FIG. 1. The analysis unit 107 comprises a database that contains medical information in the form of healthcare database records relating to specific patients, and general health related information such as available drugs and diagnostic ranges. General health related information is any information that is useful in analyzing an incoming order for healthcare. For example, a clinical laboratory test ordered that is indicative of the nutritional status of a patient, may be analyzed using information from healthcare professionals such as dieticians. Such information is included in the analysis unit 107 to assist in the analysis of the incoming healthcare order. Other information such as side effects associated with certain medications, drug interactions 213 or normal diagnostic ranges may be included as part of data available to the analysis unit 107. One of skill in art will recognize that other information not specifically included in a healthcare order, may be added and stored in the analysis unit to provide a more complete basis for analysis.

When a new drug is introduced by a pharmacy 209, clinical information associated with the new drug is stored in the data store in the analysis unit 107. Information related to the newly introduced drug 209 such as existing drugs that perform similar functions (therapeutic substitutes), or medications that treat the same conditions (poly-pharmacy) 201 may be identified and included as part of the data available to the analysis unit 107. Information related to the new drug is thereby available to the analysis unit 107 when a new healthcare order is received, such as an order associated with a new admission 207 or ongoing monitoring 211 of a patient/resident currently under treatment.

When a patient/resident sees a healthcare provider for the first time relating to a new condition, a new admission 207 occurs. As part of treatment, the healthcare provider may place an order for a medication or clinical laboratory test. A clinical laboratory test result to be performed on a physical sample taken from the patient, such as blood, urine and the like. Also, a patient/resident currently under treatment, such as a patient/resident regularly checked on an outpatient basis, or an admitted patient/resident in a healthcare facility such as a hospital or nursing home, may require that a healthcare provider access the patient's/resident's medical information as part of ongoing treatment 211. Part of ongoing treatment 211 includes periodic clinical testing that may monitor certain drug levels over time or monitor conditions such as blood sugars, cholesterol and the like.

A typical order for clinical laboratory test will include substantive information relating to the reason for the test. Such substantive information may include but is not limited to, the date of the order, the patient's/resident's name, the healthcare provider ordering the test, the name of the test, a diagnosis for the patient/resident as well as other information. The substantive information relating to the clinical laboratory test ordered is translated, that is, the substantive information is identified, extracted and converted to a format that is compatible with data store within the analysis unit 107. Each new order 207 is stored in the analysis unit 107 in the form of translated substantive information for later retrieval 205. The substantive information relating to the new order 207 may be used to analyze the new order for appropriateness based on the real-time information about the patient's/resident's current condition and medical history. The patient's/resident's medical history, current condition, general health resources along with the newly placed order 207 are analyzed to determine if the order 207 will produce the desired clinical outcome and is cost efficient.

When a new order relating to a medication or drug is placed 207 the analysis unit 107 checks the order against the information available to the analysis unit 107. The new medication is analyzed with respect to possible therapeutic substitutes and poly-pharmacy 201 indications. If a similar medication is available that can produce the same desired clinical outcome with less side effects or at a cheaper cost, such a finding may be communicated to the healthcare provider placing the new order 207 in a manner that will be described in greater detail below. In addition to identifying possible substitutes and poly-pharmacy implications, the new order 207 may be analyzed for possible drug interactions with medications the patient/resident is already taking 213. The information relating to the patients current medication regimen is stored in the analysis unit 107 and was received from substantive information associated with previous orders placed for the patient.

The new order 207 may also be compared to the patient's/resident's current diagnosis to verify that the drug being ordered is appropriate for the diagnosis. 203. Patient/resident diagnoses may be included in the drug order, or may be stored in the analysis unit 107 from a previously received healthcare information associated with the patient. Previous orders for medications and clinical laboratory tests provide diagnoses for the patient/resident that are an aspect of the substantive information relating to the previous orders when they were placed. The substantive information is identified, extracted and translated to be stored in the analysis unit 107. The new order 207 is then analyzed to determine if the new order 207 is appropriate based on the known diagnoses. If an incompatibility is detected, the healthcare provider placing the new order 207 may be contacted an informed of the inconsistency. Corrective action may then be taken to ensure that the desired clinical outcome and cost effectiveness are maintained.

When a new order is placed 207, part of the analysis involves retrieving the patient's/resident's medical history through information already stored in the analysis unit 107. Clinical laboratory tests previously performed on the patient/resident are stored in -the analysis unit 107 at the time the tests were performed. Substantive information relating to the clinical test, including the results of the test are stored in the analysis unit 107 in such a way that the substantive information is available to the analysis unit 107 when analyzing a new order 207. When new order 207 is placed, stored substantive information, including past clinical laboratory test results are retrieved 205 from the analysis unit 107. Retrieved lab results 205 may be used for determining whether a drug currently being ordered 207 is supported by the patient's/resident's lab results 215. For example, if a patient/resident is under a course of treatment for anemia, and is being prescribed Procrit®, when a new order is placed for Procrit®, the patients past medical information stored in the analysis unit 107 includes previous orders for Procrit® as well as previous clinical test results for the patient's/resident's hemoglobin and hematocrit (H & H) levels. The currently ordered dosage may be compared to prior dosages and their associated clinical laboratory test results at the time the prior dosages were given. The patient's/resident's previous H & H levels may provide an indication that the current dosage is too low, or that H & H levels may indicate that the Procrit® dosage may be reduced. If the dosage prescribed in the current new order 207 seems inappropriate based on analysis, a suggestion may be made to the healthcare provider who may then consider revising the order.

The analysis unit 107 provides instant, real-time access to the patient's/resident's medical history with respect to both medications and laboratory test results. Having both types of medical information available for analysis provides an effective means of automatically evaluating new healthcare orders in light of a comprehensive picture of the patient's/resident's status. This allows the healthcare provider to make informed decisions that will lead to improved clinical outcomes. In addition to the benefits provided with improved clinical outcomes, cost savings are realized as the analysis unit 107 identifies substitute medications or identifies improper medications or dosages.

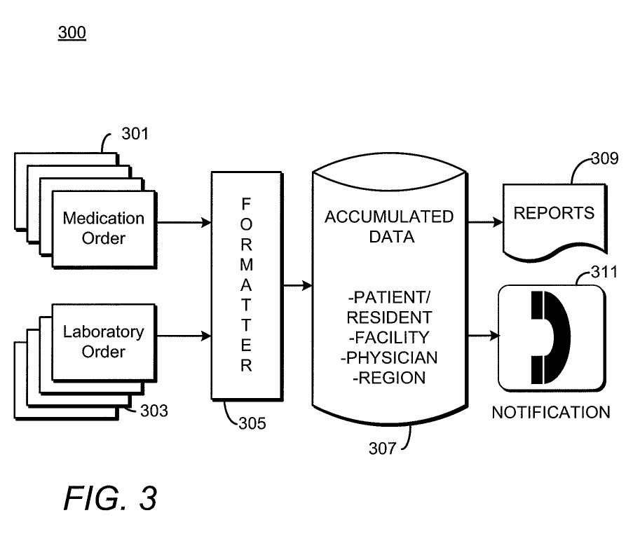

Referring to FIG. 3, a system of analysis for healthcare orders 300 is shown. When a healthcare provider orders a medication for a patient, through a prescription or other healthcare order, medical information comprising the medication, dosage and frequency are created at the pharmacy 301. Similarly, if the order is for a clinical laboratory test, medical information is created comprising the test and result 303. The medical information 301 and clinical laboratory result 303 are transmitted to a central repository 307 where the medical information and associated data are accumulated. The accumulated data will include among other things, information regarding individual patients, all patients within a common healthcare facility, all patients associated with a particular doctor, or information relating to patients sharing a particular region or other demographic attribute.

Before the data is stored and committed to the data repository 307, the data or information is translated by a formatter 305. The formatter 305 extracts the substantive data in the healthcare order 301, 303 and stores it in the repository 307 in a later accessible manner. That is, the quantitative data within the healthcare information 301, 303 is extracted and stored in a database in such a way that the data may later be extracted and analyzed for comparative analysis and reporting 309. For example, if an order was written for a patient/resident to receive 40 mg of Lasix® once daily, the dosage (40 mg), the medication (Lasix®), the diagnosis, and the frequency (once daily) would be stored in separate fields in the repository 307 as opposed to sending an image of a written record that would need to be reviewed visually by a person at a later time. Likewise, if an order for a Hemoglobin and Hematocrit (H&H) was written, the date, specimen type, test and result would be stored in the repository 307 after being formatted 305 from its native format.

When all of the data relating to the medication information 301 and the laboratory information 103 are stored in the repository 307, a new order 301, 303 may be analyzed against the prior accumulated data 307 as it is entered. Evaluation of the order 301, 303, with the expectation of validation, may occur based on various aspects of the order that will be described in greater detail below.

When an issue is detected with an order 301, 303, the central repository 307 is configured to notify the healthcare providers of the detected issue 311. Such notification may be in the form of a generated report 309 or a direct communication 311 to a healthcare provider in the form of an electronic message or the like. The healthcare provider may be the physician who placed the order, the laboratory or pharmacy carrying out the order, or the patient/resident or caregiver for whom the order was made, or any combination of the foregoing. Any other party with an interest in the process of care or administration of the medical order, including governmental administrative agencies may be notified as a healthcare provider.

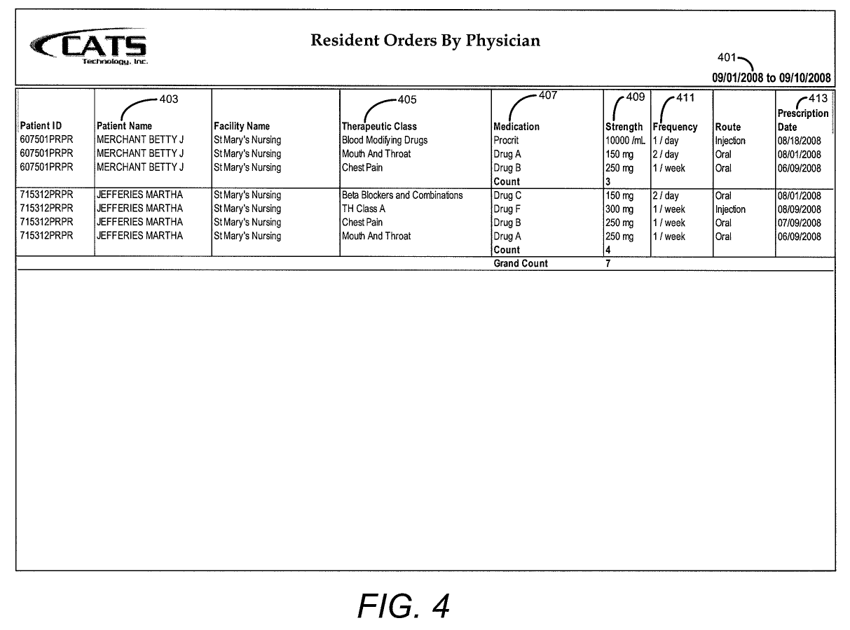

Referring to FIG. 4, a sample report is shown that indicates the current medications 407 for patients/residents 403 being treated by the same physician. The report provides a snapshot of the patients/residents' medication profile for a given date 401. The patients/residents are identified 403 and all of the medications 407 the patients/residents 403 are taking are identified by querying the repository 407 based on the received medication information 401 for the patient/resident 403.

The medications 407 are then listed by therapeutic class 405. Medications are listed by name 407, dosage 409, frequency 411 and the date the particular medication was started 413.

The report in FIG. 4 allows a healthcare provider to get a complete and accurate picture of the patient's/resident's current medication status because the information is accumulated in real-time. Information is accumulated from any number of pharmacies and laboratories, and therefore, the complete picture of the patient's/resident's medications are included in the report. The healthcare provider is provided with all of the information necessary to make a complete and informed decision about future medication orders. Duplicate medications and harmful drug interactions may be avoided.

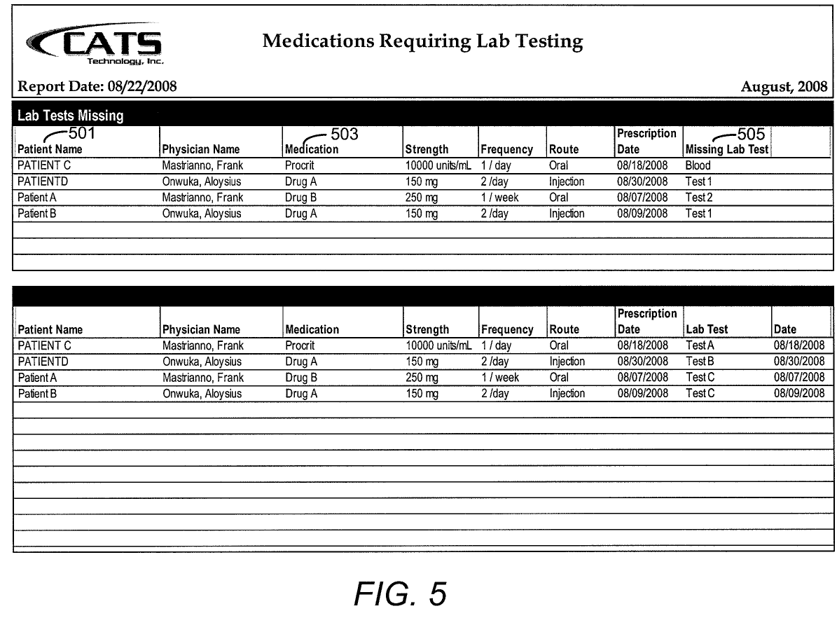

FIG. 5 shows an example of a report indicating clinical laboratory tests 505 that have not been ordered but are recommended based on a medication 503 being administered to the patient/resident 501. Because a patient's/resident's 501 complete history of medications and clinical laboratory tests are stored in a single repository, the system may be configured to report suggested clinical tests based on current medications that may have been overlooked by the healthcare provider.

Based on a patient's/resident's 501 current medications 503, the patient's/resident's 501 laboratory results are extracted from the repository. Based on the medications currently being taken 503, analysis is performed to determine appropriate clinical laboratory tests 505 based on those medications. Clinical laboratory healthcare information stored in the repository is extracted and appropriate clinical tests associated with the patient's/resident's medications are compared to the tests actually performed. If an appropriate test has not been performed 505, it is indicated in the report. Clinical laboratory tests 505 may be indicated when a medication 503 is administered, either to confirm a diagnosis associated with the prescribing of the medication 503, or to monitor the medications 503 effects and levels within the patient 501.

For example, the medication Procrit® 503 is listed for the patient/resident 501. Based on the current laboratory information for the patient/resident 501, the system identified that for Procrit® 503, a blood test 505 is appropriate and recommends the blood test 505 be considered by the healthcare provider. The ultimate medical decision is made by the healthcare provider, however suggestions based on a complete, real-time analysis of the patients current treatment regimen provides valuable assistance to the healthcare provider allowing him or her to provide the highest level of care possible.

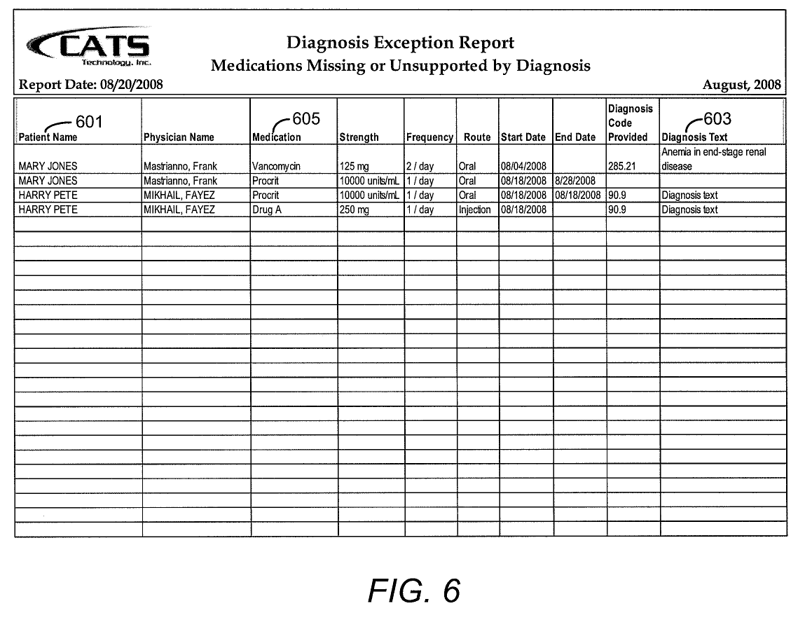

Referring to FIG. 6, a sample report is shown indicating medications that may not be appropriate for the diagnosis provided in the order. Medications may be grouped according to a diagnosis provided with the order. For some diagnoses 603, however, certain medications may be inappropriate or unnecessary. Using the data repository, a patient's/resident's 601 medications 605 may be compared to the diagnoses 603 to determine their appropriateness. When a medication 605 is associated with a diagnosis 603 that is not consistent with the medication ordered 605 it is included in the report. Likewise, a medication being administered that does not have an associated diagnosis may be included in the report. In this example, patient/resident 601 Mary Jones is receiving 1000 units/mL Procrit® but does not have a diagnosis associated with this medication. The undiagnosed treatment is identified and included in the report.

This example also shows the patient/resident 601 has been diagnosed with a anemia in end-state renal disease 603, and has the medication Vancomycin 605 ordered for that diagnosis which is inconsistent with anemia in end-state renal disease 603. It is listed in the report and communicated to the healthcare provider for review. It may be the case that the medications are necessary to treat the patient, but an incorrect diagnosis was entered when the order was made. In this case, the report allows the healthcare provider to correct the diagnosis. If, on the other hand, the order was an error, the error may be corrected without causing any further complication and unnecessary costs created by the patient/resident 601 taking inappropriate medications.

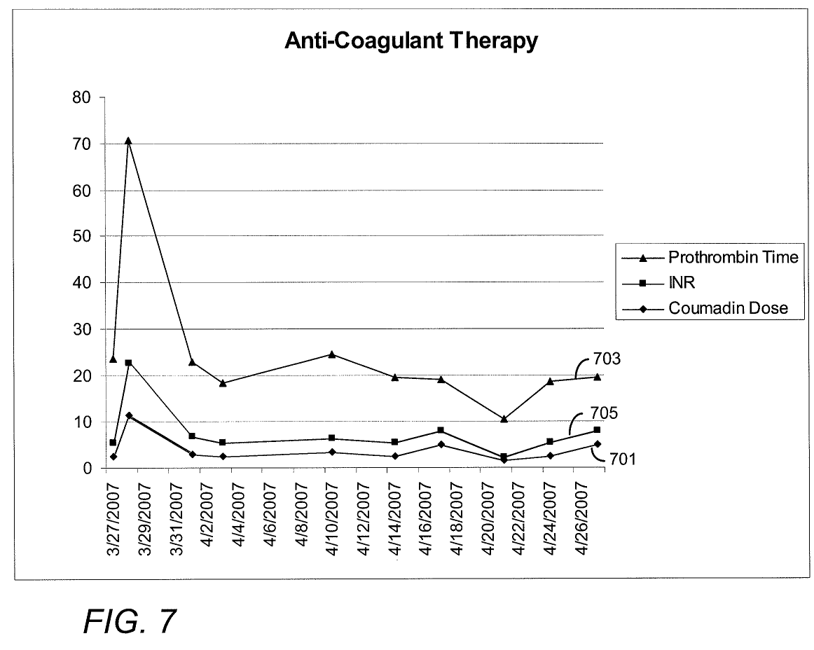

FIG. 7 shows a graph of a patient's/resident's anti-coagulant treatment history. Blood thinning therapies such as Coumadin® require extensive testing of blood samples to determine clotting rates such as Prothrombin Times (PT) and International Normalized Ratios (INR). Based on medication information containing the patient's/resident's Coumadin® dosage 701, the corresponding clinical test results for PT 703 and INR 705 are superimposed on one graph. This allows a person reviewing the patient's/resident's treatment to immediately get a picture of the patient's/resident's treatment history and the clinical outcome of that treatment. Because the repository is configured to store a patient's/resident's medical information indefinitely, the history may be provided for any desired timeframe. The data repository is queried for the patient/resident based on anti-coagulants and associated clinical laboratory tests, and the results are collated and arranged in a single graphical representation for viewing.

In an embodiment, the use of an interactive order entry procedure, may present the information in the graph of FIG. 7 to a healthcare provider placing an order for Coumadin® and give the healthcare provider information relating to the patient/resident's past doses of Coumadin® and the resulting laboratory results for PT/INR. Armed with this information, the healthcare provider makes a decision based on real-time information and decides the proper dosage of Coumadin® for ongoing treatment.

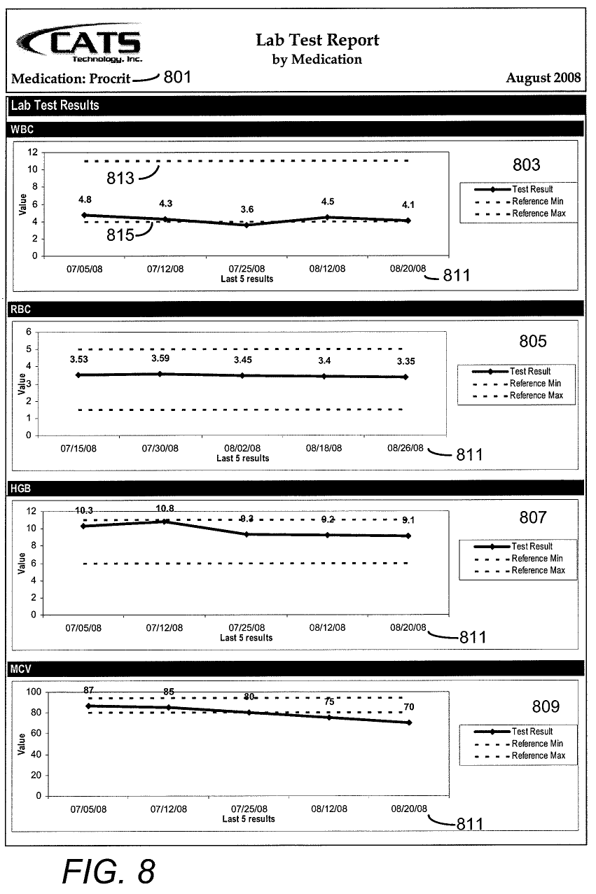

Referring to FIG. 8, a graph is shown indicating the historical results of a patient/resident's clinical laboratory results based on an administered medication. In this example, the report involves the patient/resident's use of Procrit® 801. A number of tests associated with Procrit® are included in the graph. The last 5 clinical test results for each test are included. The tests include: white blood cell count (WBC) 803, red blood cell count (RBC) 805, Hemoglobin (HGB) 807, and a Mean Corpuscular Volume (MCV) 809. The patient's/resident's history is extracted from the repository and the results are graphed on a timeline 811. Reference ranges 813, 815 are indicated to allow a quick comparison of the patient/resident's current levels with the reference range over time.

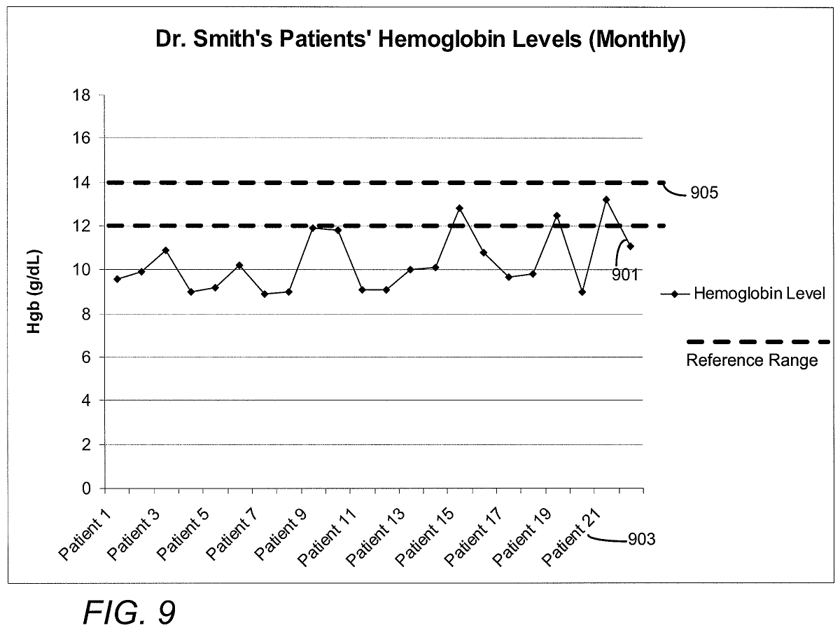

Referring to FIG. 9, a graph comprising hemoglobin levels for patients being treated by the same doctor is shown. A particular doctor's clinical outcomes may be audited to determine if the doctor's favored course of treatment is appropriate. In the context of a nursing home or hospital environment, trends may be identified in a group of patients where a clinical result is not at an acceptable level. The data repository may be queried based on a specific doctor to extract results relating to patients 903 all under the care of that doctor. For example, the hemoglobin levels 901 of some or all patients 903 under Dr. Smith's care may be collected and displayed in a single graph. The hemoglobin levels 901 may be compared to a reference range 905, and indicate whether the patients 903 treated by Dr. Smith are predominantly outside the reference range for hemoglobin. If it is noted that a vast majority of Dr. Smith's patients are not within the desired range, results may be compared with the results of other doctors and corrective action or notification to Dr. Smith, or alternatively, some auditing entity may occur.

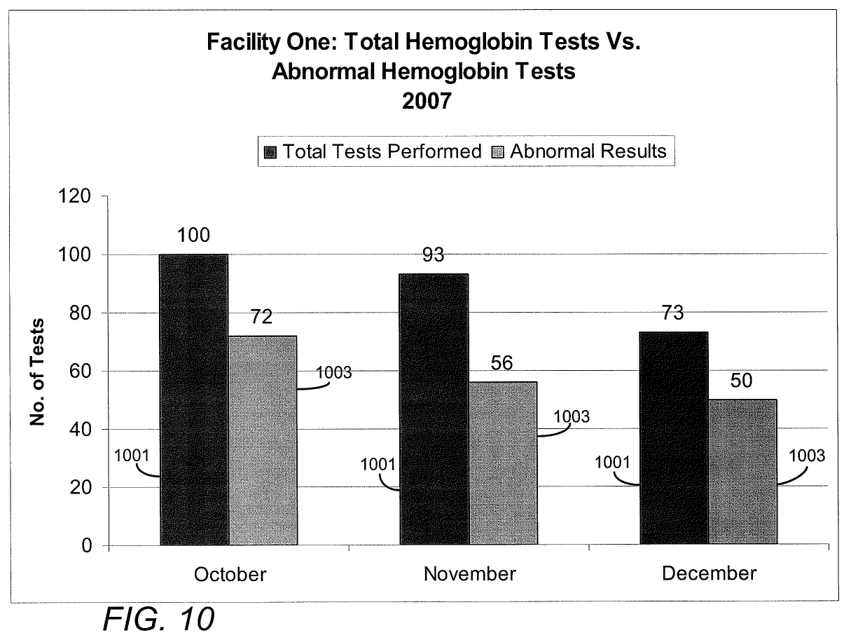

FIG. 10 shows a graph of the number of abnormal hemoglobin results 1003 compared to the total number of hemoglobin tests 1001 are shown for a facility. Monthly 1005 results are compared so that trends are easily visible within the facility. The clinical information of all patients associated with the facility is stored in the repository as the information is generated. The repository is queried based on the facility and all associated information for patients in the facility for the test of interest is extracted and accumulated for the graph. Because the information is stored in real-time as they occur, the snapshot taken at the time the graph is generated is the most up-to-date information available.

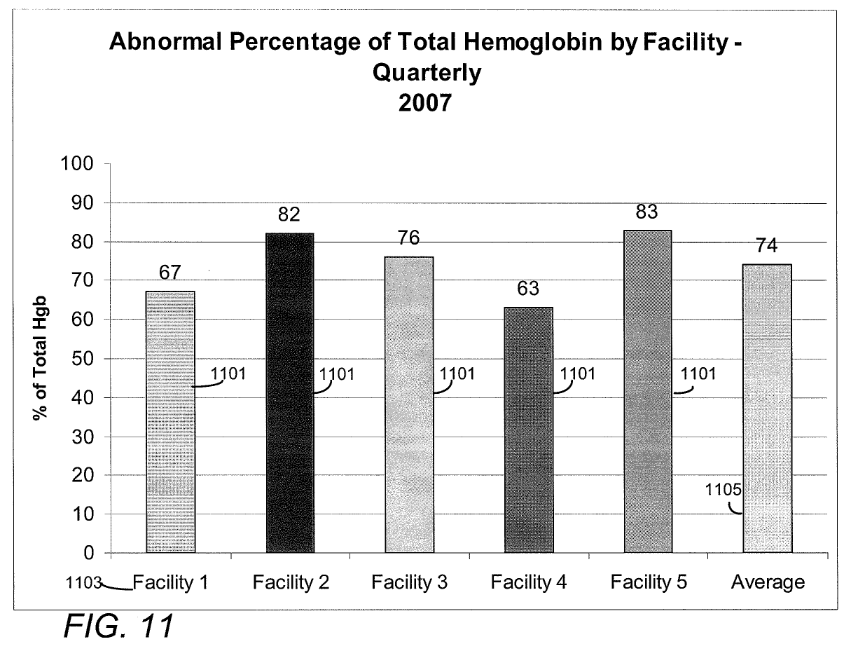

FIG. 11 depicts a graph linking multiple healthcare facilities. As healthcare organizations grow, there is a need to manage a number of facilities the pressures of oversight by administrative bodies increase. Thus the importance of managing all aspects of the facilities becomes more important. Through the use of a repository containing all of the medication and clinical laboratory information for an entire population of patients across a number of facilities, data may be extracted to provide trend analysis of performance of one facility compared to another. In FIG. 11, the percentage of abnormal hemoglobin results 1101 are displayed for a number of facilities 1103. An average 1105 of all shown facilities 1103 may be calculated for easy comparison of each facility 1103 to the average 1105. When a particular facility is experiencing a greater number of abnormal test results compared to other facilities, corrective action, or further analysis may take place.

The repository containing all the clinical information from the population of patients associated with all the facilities 1103 in the graph is queried based on a test result of interest and the parent organization associated with the multiple facilities. All the information is accumulated and analyzed for abnormal results, the abnormal results are compared to the total number of tests from the same facility and a percentage is calculated. The percentages of all facilities are averaged 1105, and each facility's percentage 1101 and the average percentage 1105 for all facilities are displayed in graphical form.

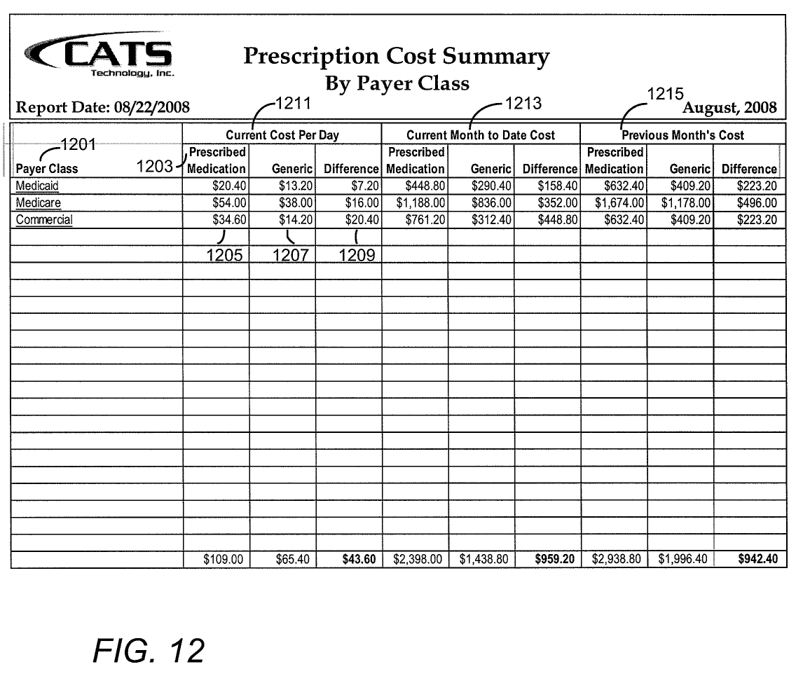

FIG. 12 shows a report of medication based on Payer Class. Based on a payer class 1201. A given prescription 1203 may be analyzed for cost. Medication costs may be arranged by a name brand drug 1205, a generic equivalent 1207 and the price difference 1209 between the two. Cost breakdowns are listed by day 1211, cost to date for the month 1213, or for the last complete month 1215. By choosing the most economical medication cost savings are realized. When a new healthcare order is received the analysis unit can analyze a patient/resident's current medications and determine if a less expensive alternative is available. When a cost saving alternative is discovered, the system may suggest the alternative to the healthcare provider, such as a primary physician, pharmacy, or facility.

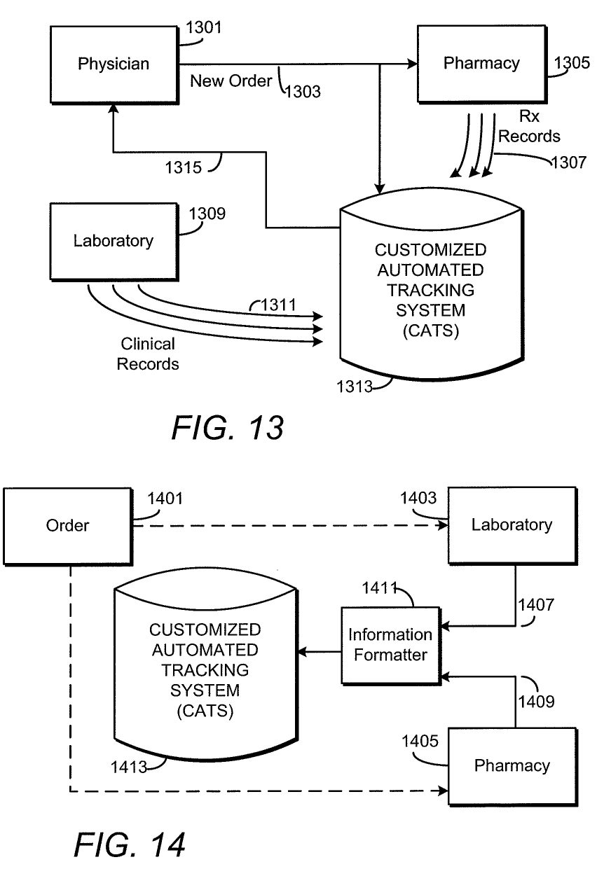

FIG. 13 illustrates a system of entering and evaluating a medication order. A healthcare provider 1301 writes an order for a new medication 1303. In one embodiment, when the order 1303 is initiated, the healthcare provider 1301 accesses the order entry system through a workstation connected to a network (not shown). Through a series of directed questions displayed at the workstation, the healthcare provider 1301 may receive real time information displayed based on current and/or past clinical laboratory results. The workstation may comprise a web-based browser interface which displays and receives input information to/from the healthcare provider 1301. The workstation is coupled to the network through any appropriate communication channel such as hard wired protocols such as ethernet or any wireless networking protocol. When the healthcare provider 1301 enters information into the web-based interface, the workstation connects to a central data repository 1313 containing a complete and real-time history of the patient's/resident's medical information. With access to prior and current medications, and a complete history of clinical testing results, the questions presented to the healthcare provider or caregiver 1301 through the web-based interface are dynamically adapted to present the healthcare provider 1301 with relevant information related to the patient's/resident's medical status. The healthcare provider 1301 may then make informed decisions regarding the ongoing care and the current order 1303 being placed.

Based on the answers to the dynamically presented questions, additional information may be correlated from the data repository 1313 relating to patients other than the patient/resident for whom the healthcare provider 1301 is currently entering an order. For example, if the healthcare provider 1301 is treating a patient/resident for a bacterial infection in a healthcare facility such as a nursing home, the data repository 1313 will contain healthcare information not only of that patient, but also other patients being treated in the same facility. By analyzing all the healthcare information relating to patients being treated in the nursing home, the healthcare information may be further filtered to include other patients who are affected by the same bacterial infection. Test results from the other patients may be analyzed and culture and sensitivity testing of the other patients may present a picture of the resistance of the bacteria in that particular facility to a range of antibiotics. Relative effectiveness and resistance to an array of antibiotics may be presented to the healthcare provider 1301 and a decision to prescribe an antibiotic with the best chance of stopping the infection may be chosen and ordered. This process allows for a quicker recovery for the patient/resident and is more cost effective because an ineffective antibiotic isn't administered that then needs to be followed by a second antibiotic treatment to try to stop the infection that the first antibiotic was unable to treat.

If the Internet is used as the communication network, a patient's/resident's history may be accessed by any healthcare provider 1301 from any facility with access to the Internet. By logging onto an Internet session, any caregiver, whether it be the family doctor using a wireless PDA from a golf course, or an emergency room physician at a hospital has the same access to the patient's/resident's history as well as the other associated medical information relating to populations of which the patient/resident is a member. The caregiver 1301 can leverage the real-time analysis of the healthcare information in the repository 1313 to make the best medical decision for the patient/resident at the least cost. The information presented to the ordering healthcare provider 1301 is not available by looking at a patient's/resident's paper records, which may be dated or incomplete, nor by looking only at the specific patient's/resident's history outside of the context provided by healthcare information of other patients that may have a bearing on the current condition of the patient.

The order 1303 is received by the pharmacy 1305 and the repository 1313. The repository 1313 is populated with previous clinical information 1311 that was created when ordered clinical laboratory tests were performed by the laboratory 1309 and the test and result were transmitted to the repository 1313 in a form suitable for data analysis of the information relating to the clinical information 1311. Previous medication orders 1307, by any previous treating healthcare provider, are generated when the presently treating healthcare provider 1301 writes an order for medication 1303. The medication order 1303, includes information such as the medication name, dosage, diagnosis and the date the medication was started. The medication information 1307 is transmitted to the repository 1313 and stored in a format that allows for data analysis of the information relating to the medication information 1207.

Using all of the information relating to the patient/resident and other demographics relating to the patient, for example, other patients at the healthcare facility where the patient/resident is being treated, the repository houses software applications that will perform comparative analysis and evaluation on the incoming order 1303. If there is an issue identified with the order 1303, such as a contraindication for the medication being order based on the patient's/resident's other medical history, a drug interaction, or an improper diagnosis, the repository 1313 may notify 1315 the healthcare provider 1301, the pharmacy 1305, or possibly the patient/resident (not shown).

FIG. 14 is a block diagram showing the input of a healthcare order 1301 to a central data repository 1413. The healthcare order 1401 may be an order for a medication, in which case it is presented to the pharmacy 1405, or a clinical laboratory test order, in which case it is forwarded to the clinical laboratory 1403. The information in the laboratory 1403 and the pharmacy 1405 may be information that represents past orders or may be a real time receipt of a current order 1401.

A real-time system of medical history management may be maintained by directly importing orders 1401 into the repository 1413 when the order is created, or previous stored information may be imported to the repository 1413 to create a central point of management of medical history that may be maintained as a real-time analysis tool going forward. Laboratory information 1407, including information such as the clinical test, patient/resident information, test result, diagnosis and date is transmitted to a data formatter 1411 that identifies and formats the quantitative information contained in the laboratory information 1407. The quantitative information is saved in a database housed in the repository 1413 for future reference and analysis. Medication information 1409, including the medication name, dosage, diagnosis, patient/resident information and date is transmitted to the formatter 1411 that identifies and formats the quantitative information contained in the medication information 1409. The quantitative information is stored in a database housed in the repository 1413 and may be accessed and analyzed at a subsequent time. The information 1407, 1409 is read by the formatter 1411 and the relevant information is extracted and formatted for the repository 1413 that creates an interface between the medication and laboratory information to give a valuable real-time analysis tool for healthcare orders as they are generated. The evaluation, validity, and appropriateness of an incoming order is available in seconds, creating the ability to almost instantly manage the quality of care as well as the cost effectiveness of the treatment. Any type of information relating to the medication information 1409 or laboratory information 1407 may be formatted and stored in the repository 1413.

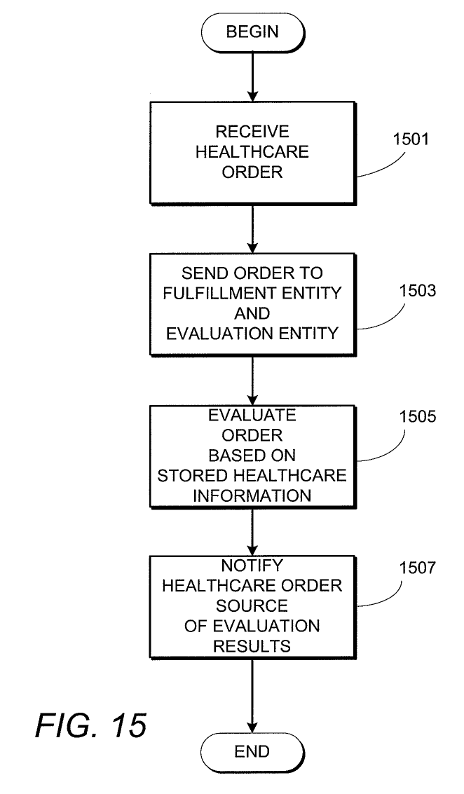

FIG. 15 shows a method of entering and evaluating a healthcare order. The healthcare order is created for either a medication or clinical laboratory as shown in step 1501. The order is then transmitted to a fulfillment entity and a evaluation entity as shown in step 1503. The fulfillment entity may be either a pharmacy or clinical laboratory. The fulfillment entity will ultimately carry out the healthcare order, in the example of a pharmacy by dispensing the ordered medication, or in the case of a clinical laboratory, by collecting appropriate samples and performing the clinical laboratory testing. The evaluation entity is an entity that takes the healthcare order and does analysis on the order to determine it's appropriateness and cost effectiveness based on the order, the patient/resident who is the subject of the order, or other factors.

The evaluation entity evaluates the order based on stored healthcare information as shown in step 1505. If the order 1501 is a medication order, the repository will evaluate the order based on other medication information relating to the patient. For example, if a currently ordered medication interacts unfavorably with a medication the patient/resident is already taking, the repository will analyze the order and determine the interaction and communicate the findings to an healthcare provider such as the ordering doctor, patient, or pharmacy. Other information may relate to the patient/resident based on some common characteristic and may include information associated with patients other than the subject of the order such as, patients being treated in the same healthcare facility as the patient/resident whose order is being evaluated. For instance, if an antibiotic was ordered to treat a specific bacterial infection, a report of sensitivities of the ordered antibiotic would be generated based on the strains of organisms that have been found in that healthcare facility. If a strain of bacteria has been identified in the facility that is resistant to the ordered antibiotic, thereby providing an indication that the treatment may not work, the repository will notify the healthcare provider, such as the doctor, patient/resident or pharmacy of its finding. The doctor may use the information to consider the appropriateness of the current order, or to change the order.

If the received healthcare order 1501 is a clinical laboratory test, the available history may be accessed to determine the appropriateness of the test, to suggest an unordered test be considered based on the patient's/resident's medications history, or to perform trending analysis based on other populations relating to the patient. For example, if an infective agent is found, regional analysis may show that the organism is becoming prevalent in a particular area such as a state, county, or a particular healthcare facility. The facility or governmental health agencies may be notified to alert them to a possible outbreak or epidemic and to allow actions to stem the spread of the organism.

Other metrics may be performed based on the clinical laboratory results of a patient, or a population in which the patient/resident is a member. For instance, a group of patients associated with a doctor or a healthcare facility may be analyzed to determine the quality and clinical outcomes of the doctor or facility.

The analysis performed by the evaluation entity will now be explained in greater detail. In an embodiment, analysis of the healthcare order is performed in the following manner. The repository containing healthcare information comprises a database, for example, a relational database may be used. When the information is formatted by the formatter, quantitative information relating to the healthcare order is identified within the healthcare order and is stored within the database in the form of tables and fields. Each piece of substantive data is stored in a data field and a plurality of data fields may be organized into a table that defines a data entity. Relationship between data entities may be established based on data elements stored in the fields that are common to more than one data entity. For example, one data entity may be a clinical laboratory result, although any type of healthcare information may be stored in a table/field format. The clinical laboratory result defines a data entity that may have, among other fields: patient, caregiver, name of test, result of test, diagnosis, patient/resident status such as fasting or non-fasting, date, healthcare facility, laboratory, patient/resident insurance carrier and the like.

Medication healthcare information may define another data entity that contains, among other fields: patient, caregiver, date, name of medication, patient/resident allergies, healthcare facility, dosage, patient/resident diagnosis, insurance carrier and the like. For the medication and laboratory data entities described above, the following common fields exist: patient, caregiver, healthcare facility, date, patient/resident insurance carrier, and diagnosis. Using these common fields relationships between the data entities exist that allow medication healthcare information or vice versa to access data elements in clinical laboratory healthcare information and to correlate all data fields of both data entities into a combined data representation based on common data fields.

For example, if medication information was created indicating Mary Smith as the patient/resident and Doctor Jones as the healthcare provider, using the database and previously stored healthcare information, laboratory results for Mary Smith could be extracted based on a common patient/resident identifier in both the medication and laboratory information. In this scenario, the laboratory results pertaining to Mary Smith may have been ordered by a healthcare provider other than Doctor Jones as the common field of interest was the patient/resident identifier. If the caregiver was used as the field being considered for analysis, the database would be queried and records extracted that all contain a healthcare provider identifier that identifies the healthcare provider making the order as Doctor Jones. In this scenario, multiple records may be extracted pertaining to more than one patient/resident as the common field under consideration was the healthcare provider identifier as opposed to the patient/resident identifier.

Multiple fields of interest may also be used for querying the database. For example, all records containing Mary Smith as a patient/resident identifier and Doctor Jones as a healthcare provider identifier would produce a set of records that pertain to orders placed for Mary Smith by Doctor Jones. Records pertaining to Mary Smith by healthcare providers other than Doctor Jones would not be included in the set. Likewise, orders created by Doctor Jones for patients other than Mary Smith would be excluded from the set.

Similar data entities and relationships could be established for records pertaining to a particular healthcare facility, or group of facilities under common administration, a geographical region, or a demographic metric.

In addition to data entities created based on stored healthcare information, other data tables and data fields may exist within the database that are based on general or medical knowledge. For example, when considering a particular medication, there are factors to consider such as whether the medication is appropriate for particular diagnosis, or whether there are other medications that interact badly with the medication. There may also be generally accepted clinical laboratory testing that is performed as a matter of course when treating with the medication. Tables in the database may be established to store these types of information. The tables may be edited or maintained based on changing medical wisdom or the introduction of new medications into the marketplace. In addition to having data entities relating to medications, other data entities may be established concerning diagnostic reference ranges or reimbursement policies based on certain tests and medications. For example, some insurance companies may have different reimbursement policies for name-brand pharmaceuticals version generic drugs. This type of information may be stored within data entities in the database. The data entities described above are provided for the purpose of example, other data entities could be developed without departing from the scope and spirit of the invention.

Using these data entities and relationships, for example, a medication may be ordered based on a provided diagnosis. Using the common field of medication name contained in the medication order a table defining that medication may be accessed and the information in that medication table may be used for analysis. If the diagnosis provided in the medication order, was not a generally accepted diagnosis for the medication based on the medication table, the order could be flagged as having an issue and communication to parties such as the healthcare provider, pharmacy or patient/resident may occur to inform the healthcare provider of the issue.

As another example, if a clinical laboratory test order was received for a glucose level and simultaneously an order for a BMP was received, a table relating to clinical laboratory tests would indicate that the glucose level is included in the BMP panel. Communication to the caregiver, clinical laboratory or the patient/resident may be initiated to prevent a duplicate test from being performed and the related overcharges from being assessed.

Step 1407 shows the communication step which communicates the evaluation results to an healthcare provider. The evaluation results may be either a finding that the order appears proper in view of the existing history, or that a potential issue has been identified of which the interested party needs to be aware. In some cases, the order may be acceptable, but a treatment option may be available that based on the existing history, may be more appropriate based on better clinical outcome or cost savings. The notification is sent to the doctor who has the ultimate authority to change the order based on the evaluation result, or the patient/resident who may then ask questions and be fully informed about his/her treatment plan. The evaluation result may also be communicated to the pharmacy before the order is filled, thereby allowing for corrective action before an inappropriate medication is dispensed and wasted.

Notification may be in form of printed reports, or electronic communications such as e-mail, facsimile, pager, text message, telephone or any other communication method that relates the evaluation findings to the involved party.

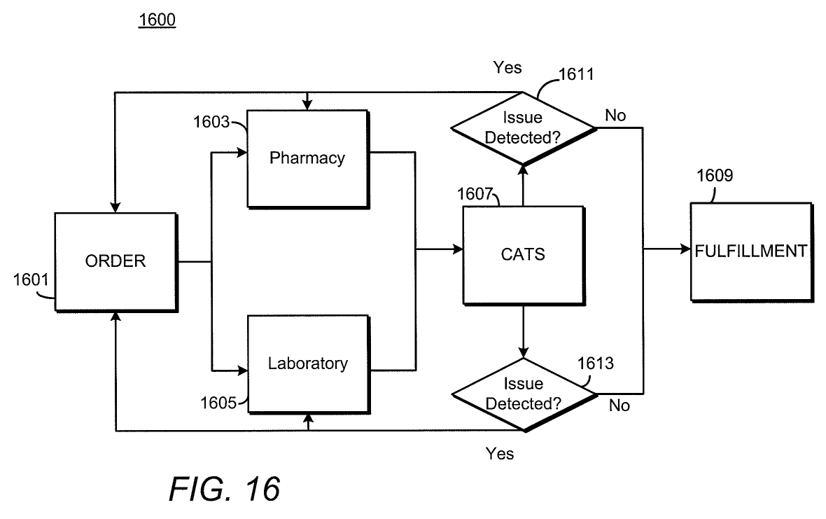

FIG. 16 shows a healthcare order evaluation system 1600. A healthcare order 1601 is created and is presented to either a pharmacy 1603 or a laboratory 1605. At the time the order 1601 is received by the pharmacy 1603 or laboratory 1605, the order 1601 is also presented to the customized automated tracking system (CATS) 1607. CATS comprises a central data repository containing healthcare information relating to the patient/resident who is the subject of the healthcare order 1601. CATS 1607 may contain a complete medical history of a patient/resident created by accumulating healthcare information relating to medications and clinical testing performed previously on the patient. Additionally, healthcare information relating to patients other than the patient/resident who is the subject of the healthcare order 1501 may be included in the CATS 1607 central data repository. The healthcare information contained in the central data repository 1607 may be accumulated from a plurality of pharmacies, clinical laboratories, or other healthcare facilities. The quantitative information relating to the order is formatted for use by software contained within CATS 1607 that performs comparative analysis, report generation, and notification communications. Through comparative analysis, the cost effectiveness and appropriateness of a given treatment plan as evidenced by the current order 1601 and the patient's/resident's healthcare history, or alternatively, the healthcare history of a demographic population of which the patient/resident belongs, may be ascertained. Should an issue be identified by the analysis, CATS 1607 may provide feedback as shown in decision block 1611 in the case of a medication 1603 order, or block 1613 in the case of a clinical test by a laboratory 1605. When an issue with the order 1601 is detected, a notification is sent back to the source of the order 1601. Notification may also be sent to the pharmacy 1603 or the laboratory 1605 before the order 1601 is fulfilled 1609. Other healthcare providers such as the patient/resident or a regulatory agency or insurer, among others may be included in notification process. If no issue is identified with the order 1601, it is then fulfilled 1609. Fulfillment 1609 may be the collection and testing of a specimen by a laboratory 1605, or the dispensing of a medication by a pharmacy 1603.

Because CATS 1607 has an up-to-date complete medical history, the analysis of the order 1601 may be done in seconds and feedback may be provided almost instantly. In this manner, communication to the order source 1601 or the pharmacy 1603 or laboratory 1505 may take corrective action should an issue with the order 1601 be identified by CATS 1607. The corrective action takes place before fulfillment 1609 of the order 1601 and prevents an unnecessary or inappropriate test from being performed or medication from being dispensed. In this manner, the quality of care is ensured and cost effectiveness is assured.

The CATS 1607 system may maintain healthcare information on any number of patients spanning any geographic area. The healthcare information of an individual patient/resident may be accumulated from any number of sources. The healthcare information is formatted and committed to a database within CATS 1607 providing a real-time analysis tool that provides instantaneous complete and accurate information about a patient/resident or population. Similar to a national credit reporting agency, the healthcare history of any patient/resident may be accessed and analyzed by a party with sufficient access to the patient's/resident's medical information. For example, government administration of a system such as medicare would allow a healthcare administrator to evaluate the overall appropriateness and cost efficiency of a course of treatment for a patient/resident or population. Auditing of healthcare facilities and doctors could be performed. Additionally, trend analysis of various populations and demographic categories could be studied allowing for standard approved treatments and accepted cost structures for reimbursement to be established easily by the administrative body.

While the above description has dealt primary with medication and clinical testing healthcare information, these are provided by way of example only and any other type of healthcare information could be stored in CATS 1507 to provide valuable analysis relating to patient/resident care.

What is claimed is:

1. A method of analyzing a healthcare order comprising the steps of:
receiving a healthcare order relating to a clinical laboratory test order or a medication order;
identifying healthcare information contained in the healthcare order;
formatting the identified healthcare information;
storing the formatted healthcare information in a central data repository as a healthcare database record;
analyzing the healthcare order based on information from the healthcare order and information previously stored in the central data repository; and
qualifying the healthcare order based on the analysis.

2. The method of claim 1 further comprising:
communicating the qualification of the healthcare order based on the analysis.

3. The method of claim 2, wherein the qualification of the healthcare order based on the analysis is reported to a primary physician.

4. The method of claim 2 wherein the qualification of the healthcare order based on the analysis is reported to a healthcare facility.

5. The method of claim 2 wherein the qualification of the healthcare order based on the analysis is reported to a patient or resident.

6. The method of claim 2 wherein the qualification of the healthcare order based on the analysis is reported to a third party reimbursement payer.

7. The method of claim 2 wherein the qualification of the healthcare order based on the analysis is reported to a pharmacy or a clinical laboratory.

8. The method of claim 2, wherein the qualification of the healthcare order is communicated in real-time to an order as the order is being placed.

9. The method of claim 2, wherein the qualification of the healthcare order is communicated in real-time to a pharmacy or clinical laboratory before the order is performed.

10. The method of claim 1, wherein a healthcare database record is based on information contained in a healthcare order that is either a medication order, or a clinical laboratory test order.

11. The method of claim 1, wherein the analyzing step further comprises:
reviewing the identified healthcare information in the healthcare order;
associating at least one informational element contained in the identified healthcare information with at least one healthcare database record stored in the central data repository, wherein the at least one healthcare database record contains the same at least one informational element; and
comparing the identified healthcare information in the healthcare order with other healthcare information contained in the associated at least one healthcare database record.

12. The method of claim 11, wherein a healthcare database record is further based on medical information not contained in a healthcare order.

13. The method of claim 11, wherein the at least one informational element contains a patient identifier.

14. The method of claim 11, wherein the at least one informational element contains a healthcare facility identifier.

15. The method of claim 11, wherein the at least one informational element contains a healthcare provider identifier.

16. The method of claim 11, wherein the at least one informational element contains a diagnosis identifier.

17. The method of claim 11, wherein the at least one informational element contains a medication identifier.

18. The method of claim 11, further comprising:
compiling healthcare information contained in the at least one associated healthcare database record;
formatting the compiled healthcare information into a readable format;
generating a report containing the formatted healthcare information.

19. The method of claim 18, wherein the at least one informational element is a patient identifier, and the compiled healthcare information contains clinical test results for an identified patient.

20. The method of claim 18, wherein the at least one informational element is a healthcare provider identifier, and the compiled healthcare information contains clinical test results for at least one patient associated with the identified healthcare provider.

21. The method of claim 18, wherein the at least one informational element is a healthcare facility identifier, and the compiled healthcare information contains clinical test results for at least one patient associated with the identified healthcare facility.

22. The method of claim 18, wherein the at least one informational element is a patient identifier and a prescribed medication identifier, and the compiled healthcare information contains clinical test results for the identified patient, wherein the compiled clinical test results information relates to the identified prescribed medication.

23. A method of compiling a real-time healthcare information database comprising the steps of:
creating a database record format for storing healthcare information;
identifying healthcare information contained in a medication order or a clinical laboratory test order;
formatting the identified healthcare information based on the healthcare database record format;
creating a healthcare database record containing the identified healthcare information;
storing the created healthcare database record in a central data repository.

24. The method of claim 23, further comprising the steps of:
creating a reference healthcare database record containing healthcare information not contained in a medication order or a clinical laboratory test order; and
storing the reference healthcare database record in the central data repository.

25. The method of claim 23, wherein creating a healthcare database record containing the identified healthcare information is performed when the medication order or clinical laboratory test order is placed.

26. A system of analyzing a healthcare order comprising:
an order entry terminal for entering a medication order or a clinical laboratory test order;
a formatter coupled and in communication with the order entry terminal configured to identify healthcare information contained in a healthcare order entered at the order entry terminal and create a healthcare database record based on the identified healthcare information;
a non-volatile memory comprising a database configured to store a created healthcare database record based on healthcare information;
a processor coupled to the non-volatile memory configured to analyze healthcare information contained in an entered medication or clinical laboratory test order and healthcare database records stored in the non-volatile memory.

27. The system of claim 26, wherein the processor is further configured to compile healthcare information contained in at least one healthcare database record and format the compiled healthcare information in a report.

28. The system of claim 27, wherein the processor is further configured to transmit the report.

29. A machine-readable storage medium containing a set of instructions, the set of instructions comprising:
an order entry code segment for entering a medication order or a clinical laboratory test order;
a formatter code section for identifying healthcare information contained in a healthcare order entered at the order entry terminal and creating a healthcare database record based on the identified healthcare information;
a database code segment for storing a created healthcare database record based on healthcare information;
a comparative analysis code segment for analyzing healthcare information contained in an entered medication or clinical laboratory test order and healthcare database records stored in the non-volatile memory.

30. The machine-readable storage medium of claim 26, further comprising:
a compilation code segment for compiling healthcare information contained in at least one healthcare database record and format the compiled healthcare information in a report.

31. The machine readable storage medium of claim 27 further comprising: a transmitter code segment for transmitting the report.
